(19) United States
(12) Patent Application Publication
(10) Pub. No.: US 2004/0172386 A1
(43) Pub. Date: Sep. 2, 2004

(54) Method and system for managing a network

(76) Inventors: Eric A. Pulsipher, Fort Collins, CO (US); Srikanth Natarajan, Fort Collins, CO (US); Gabriel Wechter, Fort Collins, CO (US); Weiwen Chen, Fort Collins, CO (US)

Correspondence Address: HEWLETT-PACKARD COMPANY, Intellectual Property Administration, P. O. Box 272400, Fort Collins, CO, 80527-2400, US

(21) Appl. No.: 10/375,359

(22) Filed: Feb. 28, 2003

(51) Int. Cl. G06F 7/00

(52) U.S. Cl. 707/3

(57) ABSTRACT

An exemplary method for managing a network includes selecting an agent based on information identifying a device in the network, contacting the device via the selected agent to extract data from the device, determining whether the agent successfully extracted the data from the device, and selecting a different agent based on the determining.

### BACKGROUND

In network topology discovery products, individual devices in a network are interrogated by software modules also known as agents. An agent decides which devices to attempt to interrogate based upon a simple static filter describing the Object IDs of a set of devices. If an object passes the agent's simple static filter, then the agent interrogates a device in the network, to determine if the device supports a feature set necessary to be modeled by that agent. If the device does not support the feature set, or if the agent cannot obtain information from the device, then nothing more is done, the agent gathers no connectivity or topology information. U.S. Pat. Nos. 6,405,248 and 6,108,702 describe monitoring systems for determining accurate topology features of a network. Methods based on agent static filters that are current only when initially deployed, are unable to robustly and dynamically handle failure of an agent in a networking environment to successfully interrogate a device where the networking environment has changed, and/or has new devices introduced into it.

### SUMMARY

In exemplary method for managing a network includes selecting an agent based on information identifying a device in the network, contacting the device via the selected agent to extract data from the device, determining whether the agent successfully extracted the data from the device, and based on the determining, selecting a different agent. A machine readable medium can include software or a computer program or programs for causing a computing device to perform the exemplary method.

An exemplary system for managing a network includes means for selecting an agent based on information identifying a device in the network, means for contacting the device via the selected agent to extract data from the device, means for determining whether the agent successfully extracted the data from the device, and means for selecting a different agent based on the determining..

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements and:

FIG. 1 illustrates an exemplary functional block diagram of an exemplary embodiment.

FIG. 2 illustrates an exemplary method.

### DETAILED DESCRIPTION OF THE EXEMPLARY EMBODIMENTS

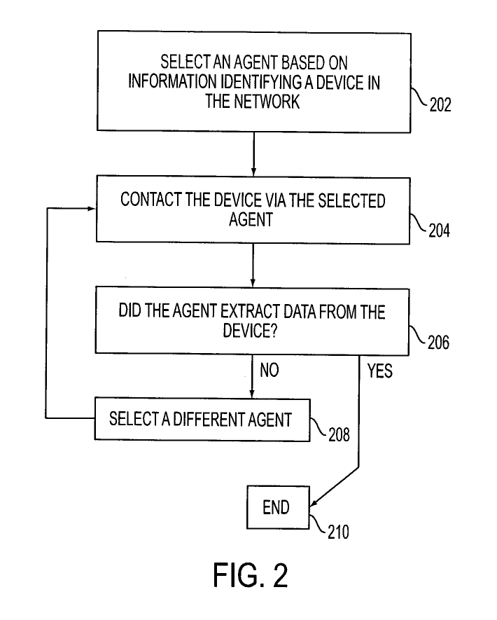

In accordance with an exemplary method, illustrated for example in FIG. 2, a network is managed by selecting an agent based on information identifying a device in the network (block 202), contacting the device via the selected agent to extract data, for example a set of necessary data, from the device (block 204), and then determining whether the agent successfully extracted the data from the device (block 206). Based on the determining, for example when the agent is unsuccessful, a different agent can be selected (block 208), and the contacting (block 204) and determining (block 206) can be repeated for the different agent. If the agent is successful, then the process can proceed to a block 210 where the process ends, and/or the extracted data is passed on. The process can then be repeated for a different device in the network. The data can include information about the device, for example a System Object Identification of the device. Success can be determined, for example, based on whether the agent extracts a threshold and/or predetermined amount, type, set or subset of data from the device. The agent (for example, a first agent, and/or any other, different agent) can be selected based on the identification information, and/or the determining.

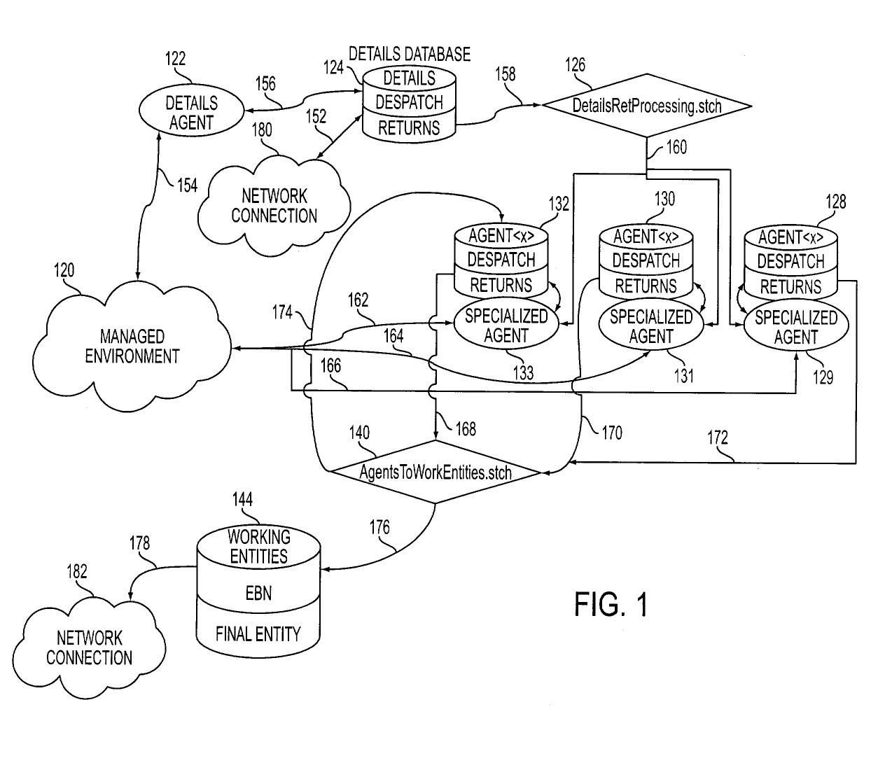

FIG. 1 shows an exemplary implementation of the method of FIG. 2. FIG. 1 shows a basic details agent 122, which can be initiated in the course of discovering a network or network topology by inserts into a despatch table of a details database 124. For example, inserts into the despatch table can occur as a result of a network device finder mechanism, for example when a file finder or ping finder finds a device in the network. The basic details agent 122 communicates with other devices or entities (including for example software modules) in a network. For example, the details agent 122 can communicate with a managed environment 120 via a link 154, and can communicate with the details database 124 via a link 156. The details agent 122 can also communicate with devices or entities in the network via the link 156, the details database 124, a network connection 180 to the network, and a link 152 between the details database 124 and the network connection 180. Other links or connections between the details agent 122 and the network can be provided.

The details agent 122 queries devices in the network, for example via SNMP (Simple Network Management Protocol), for basic information about the devices, for example a device's System Object Identification (SOID). The SOID can include, for example, vender number, etc. and typically has general information that becomes more specific toward the end of the SOID. For example, a first part of SOID can provide general information, a next part can provide more specific information, and so forth. For example, the SOID can be used to determine which specific vendor a device is from, the specific class and type of device from that vendor, and additional information. The device information sought by the details agent 122 can include an IP (Internet Protocol) address of the device(s), and/or values of other Management Information Base (MIB) variables describing attributes of the device(s).

The details agent 122 can provide the device information it received, to a details database 124. The details database 124 can include a despatch element for sending information and/or requests or instructions, and can include a returns element for receiving information. For example, the details database 124 can provide the device information to a details return processing stitcher 126 via a link 158. A stitcher is an entity that can receive and convey information, and also reformat or process the information. The stitcher 126 passes the device information to any number of agents, for example the agents 133, 131, 129, via links, for example via a link 160. The stitcher 126 can pass the information to the agents 133, 131, 129 in the form of records, or any other format.

Each of the agents 133, 131, 129 has a database or data storage element 132, 130, 128 within it or available to it, as well as pre-insert logic for initially screening or filtering the device information, for example device information based on an SOID, and for bypassing such filtering in cases where later the device information is re-routed to an agent, as shown for example with respect to link 174. In this context, “pre-insert” means that the initial screening or filtering can be the first thing that is done by an agent 133, 131, 129 with data received from the stitcher 126, even before any of the data is entered into the database or storage elements 132, 130, 128 of the agents 133, 131, 129. In an exemplary embodiment and method, the pre-insert logic is the outermost or first-encountered functional shell of the agents 133, 131, 129.

If for example an agent's logic passes an SOID in the device information, then that agent can assume responsibility for communicating with the corresponding device to extract information from the device. In this way the agent logic facilitates selection of the agent based on information identifying the device in the network, so that the selected agent will contact the device to extract data from the device. In this way the agent logic also allows such filtering to be bypassed in the case where a first agent fails to collect necessary data from the device and the device information is re-routed to another agent. For example, the devices can be located within the managed environment 120, and the agents 133, 131, 129 can communicate with the devices via links 162, 164, 166 to the managed environment 120.

In the event the selected one of the agents 133, 131, 129 successfully extracts additional information from the device, then the selected agent can add the extracted information to the record corresponding to the device that the agent received from the stitcher 126, and pass this enriched record to another stitcher such as the stitcher 140, via an appropriate one of the links 168, 170, 172 from the agents 133, 131, 129 to the stitcher 140.

The logic within the agents 133, 131, 129 allows the agents 133, 131, 129 to determine and flag cases in which they fail to gather a sufficient amount of information, possibly indicating, among other things, that the static filtering may not have made the optimal choice for which agent to send the device. For example, if the selected one of the agents 133, 131, 129 is unable to successfully communicate with the device, then the selected agent can add a note to the record to indicate this. For example, the selected agent can set a “Failed” flag in the record, or add a “Failed” flag to the record, and can then pass the record to the stitcher 140. Different situations can result in the agent setting a failure flag for a device. For example, if the agent itself is invalid or not defined, if the record fails additional filtering by the agent's logic, or if the agent obtains some but not all of the desired fundamental information about the device.

For example, each agent can have, or have specified, a separate set of data considered necessary for deducing topology, so that if the agent fails to extract the complete set of data from a device, then the agent will determine that its efforts have failed, and will record or convey that determination by, for example, setting or adding a “Failed” flag to the record for the device. Thus in an exemplary method and embodiment, the specified data set represents a threshold, and success or failure of the agent's interrogation of the device can be determined based on whether the agent extracts all data from the device necessary to fill the set. The data set sought by the agent can be a minimum amount of data describing the device, that is necessary to describe a topology of the device in a network, or the device's location and role in the network topology.

For example, consider a situation where there is a specialized agent that is designed to handle certain devices made by a certain vendor, for example switches made by Cisco. In this example we can call this agent the “Cisco switch agent”. Its purpose can include querying MIBs that are specific to that vendor (Cisco) for specific information. Its static pre-insert filter can include a description of a SOID pattern that uniquely describes the group of switches made by Cisco. Now assume that there is some Cisco switch in the network, which we will call “X”. The details agent, for example the details agent 122, will query the switch “X”, obtain the switch's SOID, and add that information to the record for the switch. That record is then passed to a details return processing stitcher, for example the stitcher 126, which then passes it on to the specialized agents, for example the agents 129, 131, 133. At this point, the specialized agents look at their filters (if there is no failed flag set, which there will not be in an initial case) to see whether to accept responsibility for querying the switch “X”. Assume that only the Cisco switch agent accepts this responsibility, since the SOID of the switch “X” matches the pattern in filter of the Cisco switch agent.

At this point, there are several exemplary reasons why the Cisco switch agent might fail to successfully extract needed information from the switch “X”, even though the switch passed the agent's filter. For example, it may be that the switch “X” does not support one or more specific MIBs (vendor-specific MIBs, for example) that the Cisco switch agent needs in order to collect what it understands to be necessary data. A simple query of a few key fields can tell the agent if those MIBs are supported on the switch “X”. If the MIBs are not supported, then the Cisco switch agent can set a failed flag and allow another (perhaps more generic) agent to try querying the switch “X”. The MIBs might not be supported, for example, if the management software deployed on the network has not been updated for several years, and Cisco develops a new family of switches (including the switch “X”) that have SOIDs that identify the switches to the software as Cisco switches, but that use new vendor-specific MIBs that didn't exist when the management software was deployed. In this scenario the Cisco switch agent will fail when it attempts to query the switch “X” because the switch “X” is using the new MIBs, and not the old, Cisco-proprietary MIBs that the Cisco switch agent is looking for. An exemplary embodiment and method can handle this situation, for example, by dynamically routing the switch “X” 's record to a specialized agent (e.g., one of the agents 129, 131, 133) that is configured as a “Standard switch agent” having the ability to query generic, common MIBs that are not specific to a vendor, and that might be supported by the switch “X”.

If when the Cisco switch agent queries the switch “X” for a set of Cisco-specific MIB values and receives the set of values in response, then the Cisco switch agent will consider its efforts to have been successful. For example, the switch “X” might have a MIB that tracks information about a Cisco-specific protocol that is commonly run over Cisco devices, and the Cisco switch agent might query the switch “X” for values from this MIB, to efficiently make decisions or determinations regarding the topology representation of the network. However, if the switch “X” did not support this MIB, then in accordance with an exemplary embodiment and method, responsibility for querying the switch “X” can be re-routed to another, for example more generic, specialized agent to gather other useful data from the switch “X”.

Here is an exemplary set of preliminary queries that an agent like the Cisco switch agent would make to determine the device supports the MIBs necessary for that to succeed in gathering useful information. First, the agent checks that the IOS (operating system) of the device is at least a certain version level or higher. (Devices that are outdated may be incapable of supporting features that this agent will need to query.) Second, the agent checks that the device supports Virtual Local Area Networks (VLANs) (since this specialized agent will later attempt to gather VLAN info about it), by checking a MIB used to store information about VLANs that run on Cisco devices. Third, the agent checks that the device supports the Bridge MIB by making a basic query to it. (Information from this MIB is necessary to construct important aspects of a topology representation, like connectivity.) If all three of the above checks pass, then the agent can know that the device supports enough MIB information for the agent to get useful topology data, and procedes to query for the rest of the information. If any fail, the agent would fail for this device, and for example a Fail flag would be set.

The stitcher 140 can include dynamic routing logic enabling the stitcher 140 to examine the records it receives for instances of Failed flags, to thereby determine whether the agent successfully extracted the data from the device. If the stitcher 140 determines that a record does not contain a Failed flag or other indication that additional efforts are necessary to extract desired information from the device, then the stitcher 140 passes the record on to a database such as the database 144 via a link 176. The database 144 can connect to other portions of the system or network or entities within the system or network (including for example software modules), for example via a link 178 and a network connection 182.

However, if the stitcher 140 detects a Failed flag in the record, then the stitcher 140 selects another one of the agents 133, 131, 129 (for example via the dynamic routing logic) and sends the record (including the Failed flag) to the newly selected agent. Thus based on the determining, a different agent can be selected. The different agent can then contact the device, modify the record corresponding to the device accordingly, and then pass the modified device record to the stitcher 140 so the stitcher 140 can determine whether the different agent successfully extracted the data from the device.

The rationale or logic of the stitcher 140's selection of another agent following a previous agent's lack of success in querying a device, can be specified in different ways. For example, a generic agent can be used as a default fallback, or a more specialized agent can be selected based on device information. Agents can also add information to the record to indicate which agents have tried to extract information from the device. For example, the stitcher 140 can select another agent using any portion or combination of the following information: device information, characteristics or capabilities of agents that were unsuccessful, an ordered list of agents, flags in the device record passed from an agent to the stitcher 140, and so forth.

For example, a generic or more general agent can be an appropriate fallback agent when the device to be queried for information has multiple Management Information Bases (MIBs), including both a proprietary and/or vendor-specific MIB and a generic MIB. So for example if the system does not have an agent equipped (for example with a protocol, with knowledge of what information the device should divulge and how to ask for it, and so forth) to properly query the device to extract information from the proprietary MIB, then a generic or more general agent can be dispatched to extract information from the generic MIB.

The stitcher 140 can provide the device record to the newly selected agent via a direct link, for example to the agent 133 via the link 174. For example, the device record can be provided directly to the database 132 in the agent 133, bypassing the pre-insert logic of the agent 133. In an exemplary embodiment, the stitcher 140 can provide the device record directly to any of the agents in a similar fashion, via direct links between the stitcher 140 and the agents 129, 131 and/or the corresponding databases 130, 133. The stitcher 140 provides the device record to the newly selected agent by placing information in the record that will allow the record to pass a particular agent's screening or filtering logic, and then sends the record to the particular agent, or to all the agents 133, 131, 129. In this way the stitcher 140 can algorithmically re-route the device record to another agent.

Each of the agents 133, 131, 129 can include logic that allows the agent's filters to be bypassed. For example, the logic can apply a rule wherein if the agent receives a record including a failure flag, then the agent assumes responsibility for talking with the device indicated by the record even if the agent would otherwise have rejected (filtered out) the record. In an exemplary embodiment, a record can include multiple failure flags, each flag can indicate which agent set the flag and/or when the flag was set and/or why the agent set the flag. Different agents can set different failure flags. Alternatively, the stitcher 140 can keep track of which agents the record has been sent to. In this way the record can be looped back multiple times by the stitcher 140, even until all agents or all appropriate agents have tried to extract information from the device. Agent logic can be implemented in an agent code parent class, for example the logic that allows flagged records to pass an agent's SOID filter. This allows, for example, the software to respond to new devices and cases dynamically after it is deployed to a customer, without having to constantly update static filtering cases and without incurring the penalty of statically routing redundantly to all agents (other agents are tried only upon failure, rather than incurring the penalty of trying all agents at once). This mechanism is also extensible to include different flag values to indicate classes of agents to which the stitcher 140 can try routing the device record. For example, if an agent which queries a specific type of switch family made by a specific vendor fails, a flag or flag value can be set, for example a flag value of 3. The routing logic in the stitcher 140 can use this value to route the device record to a generic switch-device agent. Different flags and flag values can indicate which types or classes of agents should be tried next, and/or which have already been tried.

When there are no more agents to try, either because all agents or all appropriate agents have tried unsuccessfully to extract information from the device, the stitcher 140 can then pass the record to the database 144, with an indication that the agents were unsuccessful. The indication can be, for example, a flag set within the record.

Dynamic routing as described with respect to FIG. 1 can be accomplished, for example, by executing the following pseudocode:

```
Get record information for incoming record that was just returned from
some agent.
If that record was the one describing a main node (not just one of its
interfaces) {
    If the failed flag is present, indicating that agent couldn't get useful
detailed information{
    If the record was flagged but just came from the agent of last resort{
        Turn off the failed flag.
    }else{
        Set the value of the flag dependent upon which agent tried it last.
        This value may be 0 if we don't want to route it to another
        agent.
        [Example: if ( (last agent == CiscoSwitchSnmp) OR (last
        agent == ExtremeSwitch) OR (last agent == AlcatelSwitch)) {
            Set flag to a value that will route it to a fall-back agent to
            handle switches, lets say 1.
        }]
    }
}
If the flag value == X {
        Route the record to an agent to handle class X flags by inserting
        it into the despatch table of that Agent's database along with the
        failure flag which will allow it to bypass any pre-insert filtering
        based on System Object ID.
} else if the flag value = Y {
        Route the record to an agent to handle class Y flags.
} else if ... {
        ... // Note that the logic in this section effectively implements a
hierarchical best-fit chain that can get the data back from the best possible
agent that works, and is efficient in that processing is not wasted on trying
less specific or irrelevant agents either in parallel or sequentially. It tries
the best one not yet tried, and stops upon success.
} else (it does not have a failure flag or that flag has been removed) {
        Allow it to proceed in the dataflow by inserting it into a database
to continue processing the record to build topology information.
    }
}
```

Logic to flag device records corresponding to devices that were unsuccessfully queried, as described with respect to FIG. 1, can be accomplished, for example, by executing the following pseudocode:

```
If (the record sent to the agent is not NULL) {
    Check the agent's definition.
    If the agent is not properly defined and hence not able to query the
    device
{
        Set the failure flag.
    } else {
        Attempt to retrieve the name and IP address associated with the
record.
        If this attempt fails {
            Set the failure flag.
        } else {
            Attempt to do mediation filtering.
            Query the device for a small set of fundamental information
        which will test that this agent can later attempt to gather the
        other information properly about this device.
            If mediation filtering query or queries fail {
                Set the failure flag.
            } else {
                Attempt to query device for more detailed
information.
                If we fail to gather certain important pieces of data,
                we can flag this attempt as failed.
                If it fails {
                    Set the failure flag.
                }
            }
        }
    }
    // Other criteria, specific to particular agents, for setting the failure
flag can go here (or in the code for that particular agent when it attempts
to query for more detailed information).
Else {
    Set the failure flag.
}
```

Logic to bypass initial, static SOID-based filtering of the agents 133, 131, 129, as described with respect to FIG. 1, can be accomplished, for example, by executing the following pseudocode:

```
If (the record has a failed flag) {
    Ignore all pre-insert filtering based upon the sysOID filed of that
    record.
} else {
    Apply filtering
}
```

The fault-tolerant nature of exemplary embodiments and methods conveys many advantages, including: an ability to respond dynamically to future devices after initial deployment of the system; a reduction in the amount of hard-coded agent configuration; an ability to reduce useless network management traffic by not statically configuring redundant agents to simultaneously query the same device; and an increase in the accuracy of the discovered network topology data.

The methods, logics, techniques and pseudocode sequences described above can be implemented in a variety of programming styles (for example Structured Programming, Object-Oriented Programming, and so forth) and in a variety of different programming languages (for example Java, C, C++, C#, Pascal, Ada, and so forth).

Those skilled in the art will appreciate that the elements and methods or processes described herein can be implemented using a microprocessor, computer, or any other computing device, and can be implemented in hardware and/or software, in a single physical location or in distributed fashion among various locations or host computing platforms. The agents can be implemented in hardware and/or software or computer program(s) at any desired or appropriate location. Those skilled in the art will also appreciate that software or computer program(s) can be stored on a machine-readable medium, wherein the software or computer program(s) includes instructions for causing a computing device such as a computer, computer system, microprocessor, or other computing device, to perform the methods or processes.

It will also be appreciated by those skilled in the art that the present invention can be embodied in other specific forms without departing from the spirit or essential characteristics thereof, and that the invention is not limited to the specific embodiments described herein. The presently disclosed embodiments are therefore considered in all respects to be illustrative and not restrictive. The scope of the invention is indicated by the appended claims rather than the foregoing description, and all changes that come within the meaning and range and equivalents thereof are intended to be embraced therein.

1. A method for managing a network, comprising:
selecting an agent based on information identifying a device in the network;
contacting the device via the selected agent to extract data from the device;
determining whether the agent successfully extracted the data from the device; and
based on the determining, selecting a different agent.

2. The method of claim 1, comprising:
repeating the contacting and determining for the different agent.

3. The method of claim 1, wherein the data comprises information about the device.

4. The method of claim 3, wherein the data comprises a System Object Identification of the device.

5. The method of claim 1, comprising: selecting the agent based on the identification information.

6. The method of claim 1, wherein the data is a predetermined type of data.

7. The method of claim 1, wherein the data is a predetermined set of data.

8. A system for managing a network, comprising:
means for selecting an agent based on information identifying a device in the network;
means for contacting the device via the selected agent to extract data from the device;
means for determining whether the agent successfully extracted the data from the device; and
means for selecting a different agent based on the determining.

9. The system of claim 8, comprising:
means for repeating the contacting and determining for the different agent.

10. The system of claim 8, wherein the data comprises information about the device.

11. The system of claim 10, wherein the data comprises a System Object Identification of the device.

12. The system of claim 8 comprising: selecting the agent based on the identification information.

13. The system of claim 8, wherein the data is a predetermined type of data.

14. The system of claim 8, wherein the data is a predetermined set of data.

15. A machine readable medium comprising a computer program for causing a computer to perform:
selecting an agent based on information identifying a device in the network;
contacting the device via the selected agent to extract data from the device;
determining whether the agent successfully extracted the data from the device; and
based on the determining, selecting a different agent.

16. The medium of claim 15, wherein the computer program causes the computer to perform:
repeating the contacting and determining for the different agent.

17. The medium of claim 15, wherein the data comprise information about the device.

18. The medium of claim 17, wherein the data comprise a System Object Identification of the device.

19. The medium of claim 15, wherein the computer program causes the computer to perform:
selecting the agent based on the identification information.

20. The medium of claim 15, wherein the data is a predetermined type of data.

21. The medium of claim 15, wherein the data is a predetermined set of data.
